(19) United States
(12) Patent Application Publication
(10) Pub. No.: US 2022/0346361 A1
(43) Pub. Date: Nov. 3, 2022

(54) BANK FISHING ROD HOLDER STAND

(71) Applicants: Derwyn Grant Golden, Stockbridge, GA (US); Robert Alan Bess, Yorktown, IN (US); Billy J. Bess, Yorktown, IN (US)

(72) Inventors: Derwyn Grant Golden, Stockbridge, GA (US); Robert Alan Bess, Yorktown, IN (US); Billy J. Bess, Yorktown, IN (US)

(21) Appl. No.: 17/568,971

(22) Filed: Jan. 5, 2022

Related U.S. Application Data
(60) Provisional application No. 63/181,286, filed on Apr. 29, 2021.

(51) Int. Cl. A01K 97/10

(52) U.S. Cl. CPC A01K 97/10

(57) ABSTRACT

The bank fishing rod holder stand attaches to a fishing rod holder, which connects to a fishing rod, supporting the rod and reel at the desired angle when set on surfaces such as dirt, grass, ice, or snow. The bank fishing rod holder stand is used while still-fishing, a fishing technique whereby the rod and reel are not held in the hand while waiting for a fish to bite the bait. The bank fishing rod holder stand keeps the rod and reel out of sand, snow, mud, dirt, etc., and provides a secure way of preventing larger aggressive fish from pulling the rod and reel out of the rod holder and into the water when the fish takes the bait. The bank fishing rod holder stand anchors to the ground, utilizing a metal spiral stake or non-spiral stake, inserted through the hole in the base of the stand.

### BACKGROUND OF THE INVENTION

Fishing from the bank is enjoyed by millions of people annually. Some people catch fish for consumption, while others fish just for the pleasure and enjoyment of fishing. Various bank fishing rod holders and props such as rocks, sticks, and other items are utilized for positioning fishing rods of all types in place while waiting for a fish to bite. While most bank fishing rod holder devices provide good ways of holding the rod in place, few, if any, can keep larger fish from grabbing the bait and running off with the rod and reel. This occurs so frequently that it forces fishermen to sit or stand closer to their rods or hold them in their hands to prevent this from happening. Some fishing reels have clickers, releasing the fishing line's tension when a larger fish bites the bait, allowing the fish to freely run with the line so that it does not carry the rod and reel with it. A clicking sound alerts the fisherman that a fish has taken the bait, giving him time to pick up his rod, and reel the fish onto the bank, thus preventing his fishing gear's loss.

### BRIEF SUMMARY OF THE INVENTION

The purpose of the bank fishing rod holder stand is to allow a fisherman a way of securing his rod and reel in place utilizing a fishing rod holder; fastened to the top of the bank fishing rod holder stand, and a spinning or casting rod and reel placed into the rod holder and positioned to the preference of the fisherman. The bank fishing rod holder stand sits on the ground, secured in position with a spiral or non-spiral stake, utilizing the hole on the bank fishing rod holder stand's base. The non-spiral stake is hammered or pushed through the hole, while the spiral stake is twisted through the hole and into the ground, securing the bank fishing rod holder stand into place. While some bank fishing rod holder inventors may boast about the lightweight and flexibility of their product, the bank fishing rod holder stand provides a sturdy and secure way of preventing the loss of the fisherman's rod and reel when a large, aggressive fish pull the bait. In this case, a reel with a clicker is unnecessary, allowing the fisherman time to relax without having to worry about quickly running over to his rod and securing it in his hand before a fish runs off with the fishing gear. Numerous bank fishing rod holders are limited to dirt and grass surfaces but the said bank fishing rod holder stand is suitable for grass, snow, mud, dirt, sand, gravel, and other terrain surfaces.

### BRIEF DESCRIPTION OF THE DRAWINGS

Some embodiments of the present invention are illustrated as an example and not limited by the figures of the accompanying drawings, in which like references may indicate similar elements in which:

FIG. 1 is a perspective view of one example of the bank fishing rod holder stand in operational mode, according to various embodiments of the present invention.

FIG. 2 is an exploded perspective view of one example of the bank fishing rod holder stand, according to various embodiments of the present invention.

FIG. 3 is a sectional perspective view of one example of the top component of the bank fishing rod holder stand, according to various embodiments of the present invention.

FIG. 4 is a front perspective view (the bank fishing rod holder stand facing the body of water) of one example of the bank fishing rod holder stand, according to various embodiments of the present invention.

FIG. 5 is a rear perspective view (the bank fishing rod holder stand facing away from the body of water) of one example of the bank fishing rod holder stand, according to various embodiments of the present invention.

FIG. 6 is a second rear perspective view of one example of the bank fishing rod holder stand, according to various embodiments of the present invention.

FIG. 7 is a perspective view of a double unit of the bank fishing rod holder stand in operational mode, according to various embodiments of the present invention.

FIG. 8 is a front perspective view (the side facing the body of water) of one example of the double unit of the bank fishing rod holder stand, according to various embodiments of the present invention.

FIG. 9 is a rear perspective view (the side facing away from the body of water) of one example of the double unit of the bank fishing rod holder stand, according to various embodiments of the present invention.

FIG. 10 is an exploded perspective view of one example of the bank fishing rod holder stand as a double unit, according to various embodiments of the present invention.

FIG. 11 is a second rear perspective view of one example of the bank fishing rod holder stand in operational mode, according to various embodiments of the present invention.

### DETAILED DESCRIPTION OF THE PREFERRED EMBODIMENTS

The present disclosure is to be considered as an exemplification of the invention and is not intended to limit the invention to the specific embodiments illustrated by the perspective drawings of the descriptions below.

The present invention describes an innovative way to secure a fishing rod and reel in place while fishing from the bank of a body of water. More specifically, but not limited to, a boat fishing rod holder that can be attached to the top component of the bank fishing rod holder stand in the same manner used to secure a boat fishing rod holder to a boat's railing, gunwale, or deck. Secondly, utilizing a spiral or non-spiral stake for securing the bank fishing rod holder stand's base component to the bank's surface (bank's surface refers to “sand,” “gravel,” “dirt,” “grass,” “snow,” “ice,” or “mud”).

The disclosure of the invention described herein below represents the preferred embodiments of the invention; however, variations thereof, in the form, size, construction, and arrangement of the various components thereof and the modified application of the invention are possible without departing from the spirit and scope of the appended claims.

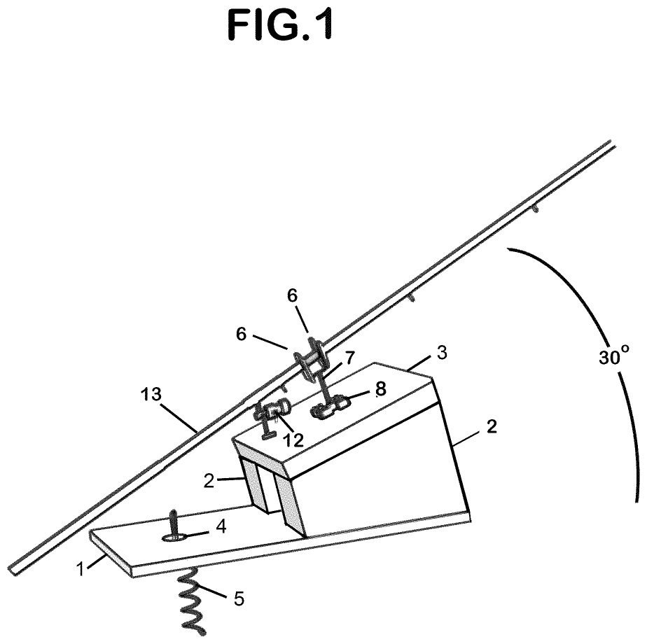

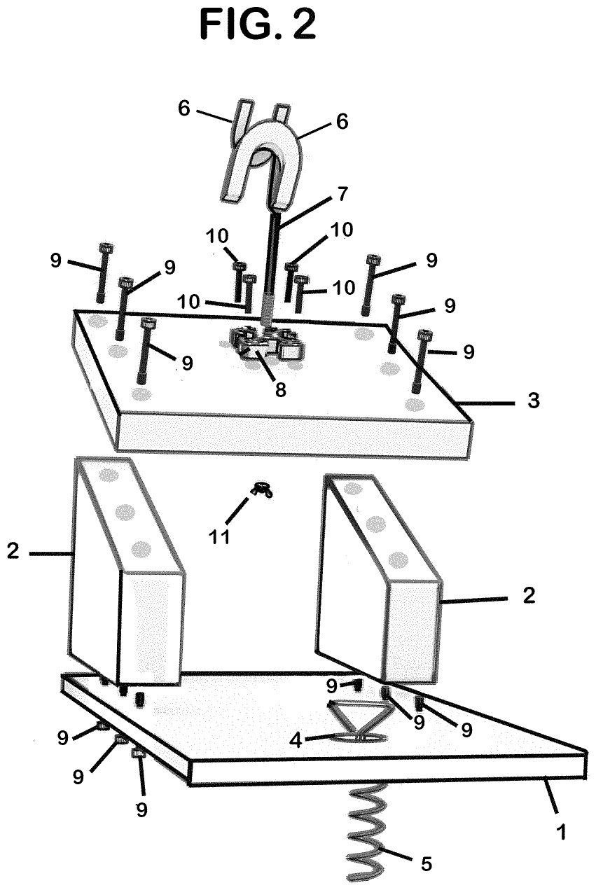

The present invention will now be described by referencing the appended figures representing preferred embodiments. FIG. 1 shows a perspective view of the components that may comprise the bank fishing rod holder stand in operational mode with a rod 13, and reel 12, attached. In preferred embodiments (referencing FIG. 2 until otherwise stated) a fishing rod holder 6 is attached to the rod holder mounting plate 8 at the shank portion 7 of the rod holder 6. The shank portion 7 extends through the top component 3, fastened into place using a wing nut 11 underneath component 3. The top component 3, is attached to the side components 2, which are attached to the base component of the bank fishing rod holder stand 1, using the type and length of screws, depending on the composition of the bank fishing rod holder stand: i.e., wood, plexiglass, plastic, metal, etc. Number 9 shows one-and-a-half-inch galvanized wood screws used to attach the top component 3 to the side components 2, and the side components 2 to the base component of the bank fishing rod holder stand 1. One-inch wood galvanized screws 10, attaches the rod holder mounting plate 8 to the top component 3. When attached to the top component 3, the side components 2 can be cut to position the top component 3 parallel with the base component 1, or side components 2, can be cut at an angle to provide an incline position to the top component 3, allowing the fishing rod 13, FIG. 1, to sit in the fishing rod holder 6 at a thirty-degree angle, more or less, depending on the angle dimensions of the side components 2 when the bank fishing rod holder stand is secured to the bank's surface. FIG. 1 shows the fishing rod 13 positioned at a thirty-degree angle in reference to the bank's surface. Component dimensions may vary in length, height, and width depending on the composition and/or design of the bank fishing rod holder stand, and may also be determined by the make, model and size of the fishing rod and reel used as well as the size of the rod holder dimensions.

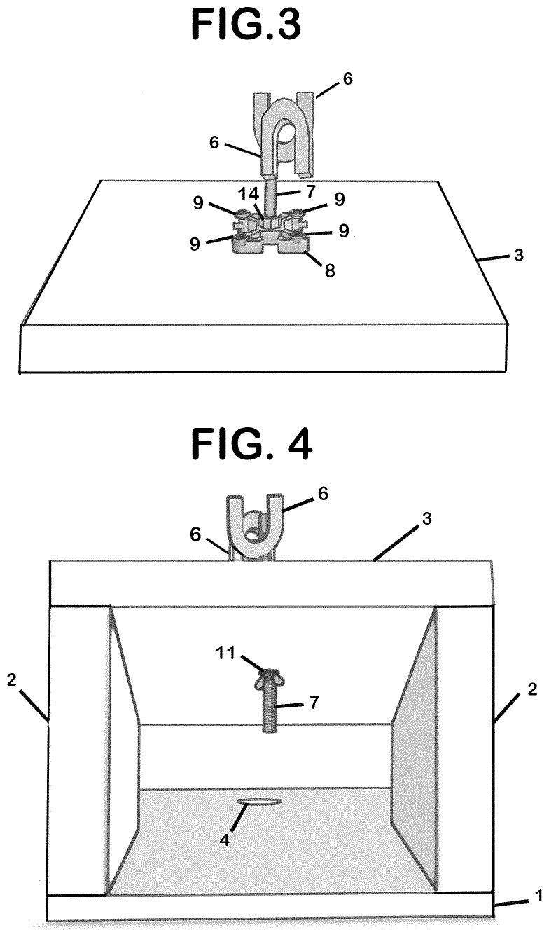

FIGS. 3 and 4 show two different perspective views that the fishing rod holder stand can be secured to the top component 3. FIG. 3 shows a sectional perspective view of the top component 3 with the shank portion of the fishing rod holder 7 fastened to the top of the fishing rod holder's mounting plate 8 using a lock nut 14. FIG. 4 shows a front perspective view of the bank fishing rod holder stand with the shank portion of the fishing rod holder 7 extending through the bottom of the top component 3 with a wing nut 11 screwed onto the shank portion 7 of the fishing rod holder 6. The wider opening of the front perspective view shown in FIG. 4 allows a fisherman to reach underneath the top component 3 of the bank fishing rod holder stand and easily fasten a lock or wing nut into place. In this example, a wing nut 11 is used.

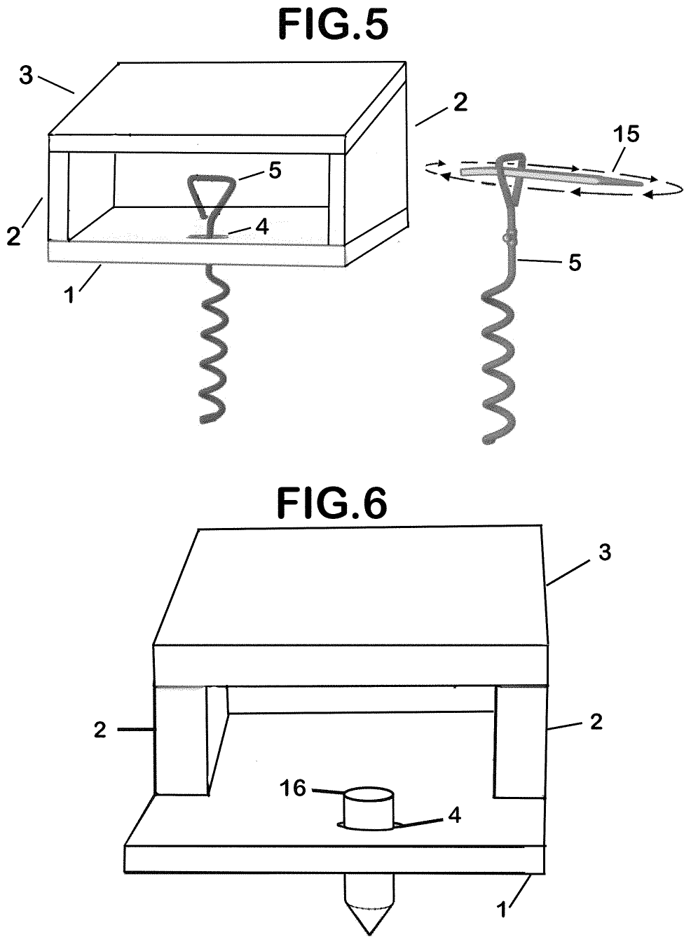

A rear perspective view of the bank fishing rod holder stand, FIG. 5, shows a metal spiral stake 5 used to anchor the base of the bank fishing rod holder stand 1 to the bank's surface. A metal spiral stake 5 is comprised of a durable metal such as steel while a non-spiral stake's composition can be of “wood,” “metal,” “plexiglass,” or different material. The metal spiral stake, also named “metal spiral anchor tie-out,” “dog ground stake,” or “dog tie-out stake,” is twisted by hand through hole 4 of the base component 1, which anchors and secures the bank fishing rod holder stand to the bank's surface. A torquing device can be used, if needed, to secure the metal spiral stake into the ground. The device can be a tool, such as a screwdriver or other object used as a torquing device. In FIG. 5, a small crowbar 15 is shown as a torquing device that is inserted into the handle of the metal spiral stake 5 and turned clockwise until the metal spiral stake is secured to the ground. A second rear perspective view of the bank fishing rod holder stand, FIG. 6, shows a non-spiral stake 16 used as an anchoring device which is pushed or hammered through the hole 4 in the base of the bank fishing rod holder stand 1. A non-spiral stake is any object inserted through hole 4 of the base component 1 used to anchor the bank fishing rod stand into place.

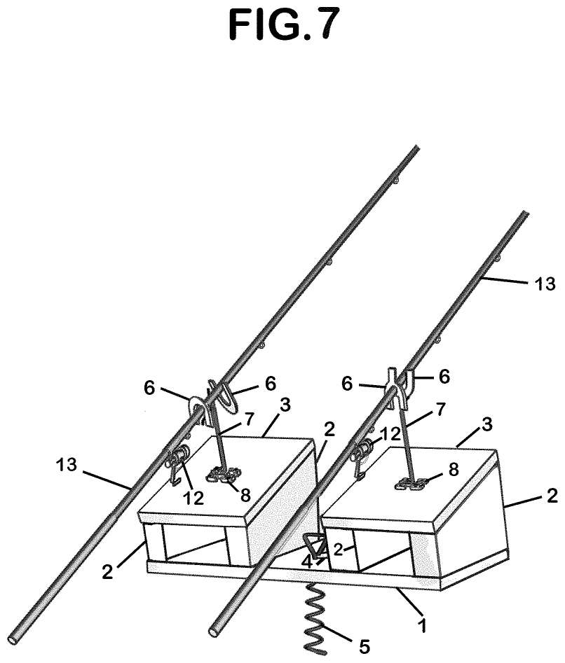

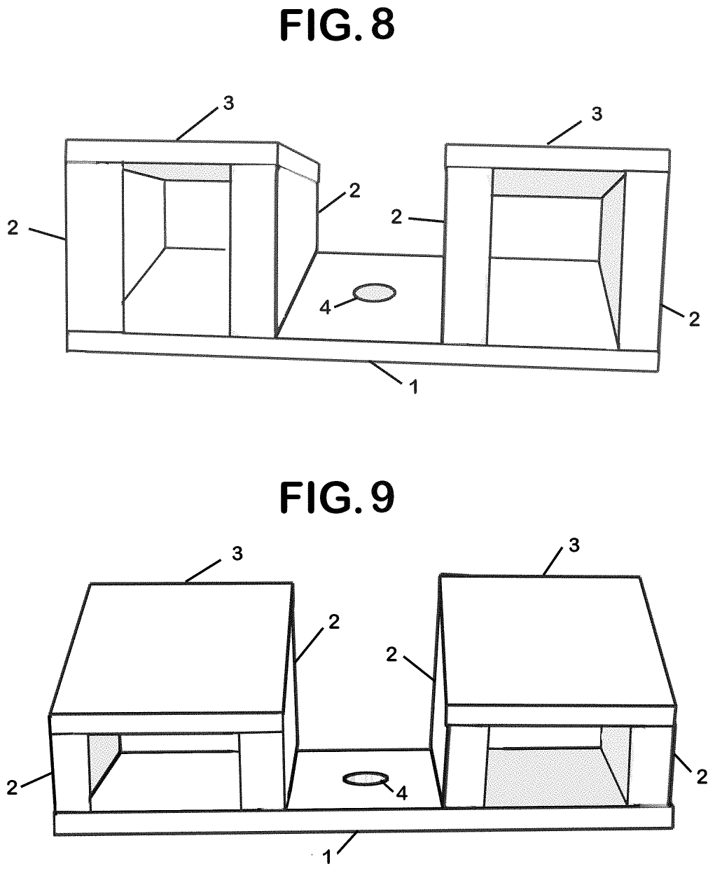

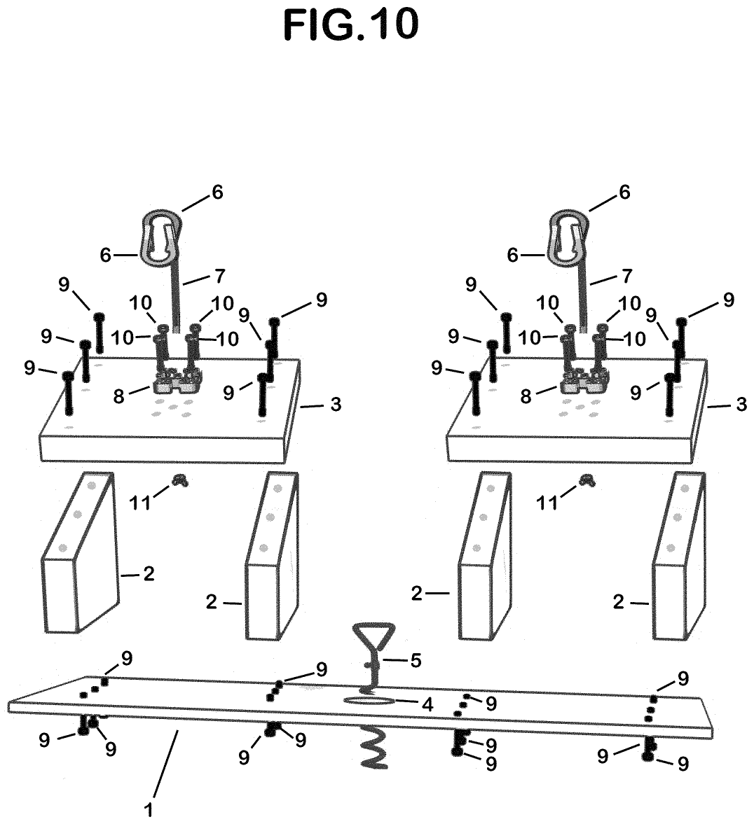

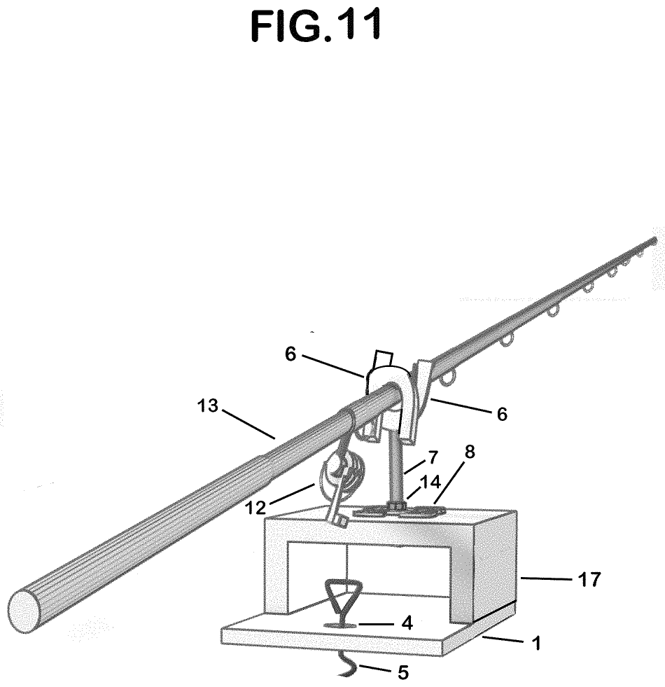

The bank fishing rod holder stand can be constructed in single or multiple units. FIG. 7 shows a perspective view of a double unit in operational mode. FIG. 8 shows a front perspective view, and FIG. 9 shows a rear perspective view. The hole 4 is used to anchor the bank fishing rod holder stand in place, using a spiral or non-spiral stake and is positioned in the middle of the base component 1, between the two units, FIGS. 8 and 9. FIG. 10 shows an exploded view of the bank fishing rod holder stand as a double unit.

FIG.11 shows another variation of the construction of the bank fishing rod holder stand in operational mode, displaying a rear perspective view, whereby component 17 is made into a single piece, eliminating the top and side components. The single-component 17, is attached to the base component 1 in the same or similar manner as the side components described in FIG. 2.

What is claimed is:

1. A bank fishing rod holder stand comprising:
a top, side and base component;
a rear and front end;
a top component used for attaching a fishing rod holder;
a fishing rod holder mounting plate attached to the top component for securing a fishing rod holder;
a fishing rod holder attached to the fishing rod holder mounting plate for holding a handle portion of a fishing rod; and
a spiral or non-spiral stake inserted through the hole of the base component of the stand wherein the stake extends substantially vertically when inserted into the ground; and
a torquing device made of durable medal such as a steel crowbar or other tool placed into the handle of the spiral metal stake to facilitate securing the metal spiral stake into the ground.

2. The bank fishing rod holder stand as set forth in claim 1, side cut out portion being formed in one (single component) or multiple components at a predetermined angle with respect to said top component of said stand.

3. The bank fishing rod holder stand of claim 1 wherein the stand is anchored to the ground using a spiral or non-spiral stake.

4. The bank fishing rod holder stand of claim 1 wherein the spiral stake comprises of a durable metal such as steel.

5. The bank fishing rod holder stand of claim 1 wherein the non-spiral stake comprises of a durable metal or nonmetal material such as wood, plexiglass or other nonmetal material.

6. The bank fishing rod holder stand of claim 1 that can be made in different sizes and dimensions.

7. The bank fishing rod holder stand of claim 1 that can be made in single or multiple units.

8. The bank fishing rod holder stand of claim 1 that can be made with different materials.
